(19) United States
(12) Patent Application Publication
(10) Pub. No.: US 2015/0302307 A1
(43) Pub. Date: Oct. 22, 2015

(54) Journal Manuscript Submission Decision Support Method and System

(71) Applicant: Gen Ming Guo, Lujhu (TW)

(72) Inventor: Gen Ming Guo, Lujhu (TW)

(21) Appl. No.: 14/256,962

(22) Filed: Apr. 19, 2014

(51) Int. Cl. G06N 5/04; G06Q 50/20

(52) U.S. Cl. CPC G06N 5/045; G06Q 50/20

(57) ABSTRACT

This innovation is to create one journal manuscript submission decision support method and system. It includes three major subsystems which are Decision Factor Filtering System, Manuscript Submission Decision Support System and Decision Model Verification System. Using on-line questionnaire module can collect and filter the critical decision factors. Through the statistics analysis, the weighted decision factors can be stored on the factor weight model database. After combining with periodical database, the manuscript submission decision support system can generate the ranking journal list which assists author(s) to submit their research papers to the suitable academic journal. The decision model verification system verifies the usefulness and easy-to-use of this Journal Manuscript Submission Decision Support System. The decision model can be fine-tuned by verification system. The critical decision factors can be filtered out. Finally, it can reduce authors' time to look for suitable journal.

### CROSS REFERENCE TO RELATED APPLICATION

This is a Continuation-In-Part application of U.S. patent application Ser. No. 12/611,928 filed on Nov. 3, 2009. The contents of the aforementioned application are incorporated herein by reference.

### FIELD OF THE INVENTION

The present invention pertains to the field of a method and a system which are carried out by a physical computer. More specifically, the present invention relates to one kind of decision support method and system to help an author to select and filter suitable academic journal from more than ten thousands of journals in order to submit their manuscripts. This method and system can generate and provide one recommended journal list which takes account of different author's preferences.

### BACKGROUND OF THE INVENTION

It is generally at the academia field for professor, faculty, graduate student or researcher etc. to publish and unveil their innovation or discovery on the academic journal. Each journal has its own features, audiences, policies and focuses. Therefore, authors must survey and learn more about different journals which would be close to their research subject field. If authors don't survey this well, the reject rate would increase. And then it would initiate another turn-around trip for the manuscript. Currently, the peer review, revision or rejection processes often took a long period of time in real world. How to choose the suitable journal to submit becomes critical issue in order to reduce the reject rate and save paper-trip time.

At least ten thousands of journals published in the world. It was impossible for author to screen all journals. And most authors' choice and decision were limited to personal cognitions. Editor-in-chief and editorial board members sometimes change the journal title or collection subjects after several years. Take full advantage of support system, it can detect these changes and recalculate paper keyword frequency. It can provide up-to-date information and intelligence for scholars. If authors can get the latest intelligence about journals, they could make the better decision when they have to choose one journal to submit their manuscript.

### SUMMARY OF THE INVENTION

One manuscript submission decision support system was designed in this research. It was designed to help scholars to choose suitable journals in order to submit their manuscripts. That was because scholars have difficult to recognize and remember too much journals. After authors submit their paper in this manuscript submission support system, the manuscript submission management subsystem can assist registered users to maintain their submission status or history record. Manuscript submission decision support system can exchange data with general online paper submission and peer-reviewed system via manuscript submission management subsystem.

Decision Factor Filtering System was designed to filter key variables which most authors consider them. Through Basic Decision Factor On-line Questionnaire Module and AHP Decision Factor On-line Questionnaire Module, different factors would be collected and ranked. Both Statistic and AHP (Analytic Hierarchy Processing) were used to calculate the decision factor weight. Those factor weights were saved in Factor Weight Model DB.

Manuscript Submission Decision Support System not only gets the users' preferences from on-line GUI (Graphic User Interface) but also get the Factor Weights from Factor Weight Model DB. There are four key steps in this system. They are intelligence, design, choice and implementation steps. Several key factors would be calculated such as article language, indexed DB, journal classification, journal impact factor, article amount of specific subject in journal and so on.

Decision Model Verification System was designed to verify the proposed model in this research. The Technology Acceptance Model (TAM) was used here. There are three key parts in TAM model; 1) Easy to Use; 2) Usefulness; 3) Accuracy. Through this system, the new model could be evaluated and fine tuned in order to increase its reliability and validity. In this way, Decision Model Verification System can be fit to users' requirement more.

### BRIEF DESCRIPTION OF THE DRAWINGS

FIG. 1 is a diagram of the whole system architecture including three subsystems.

FIG. 2 is a diagram of the Decision Factor Filtering System.

FIG. 3 is a diagram of the Manuscript Submission Decision Support System.

FIG. 4 is a diagram of Decision Model Verification System.

### DETAILED DESCRIPTION OF THE PREFERRED EMBODIMENT

In order to reveal the technology used in this research, the further disclosures such as innovation purpose, system function and so on, would be described in the following section. The related figures would be explained.

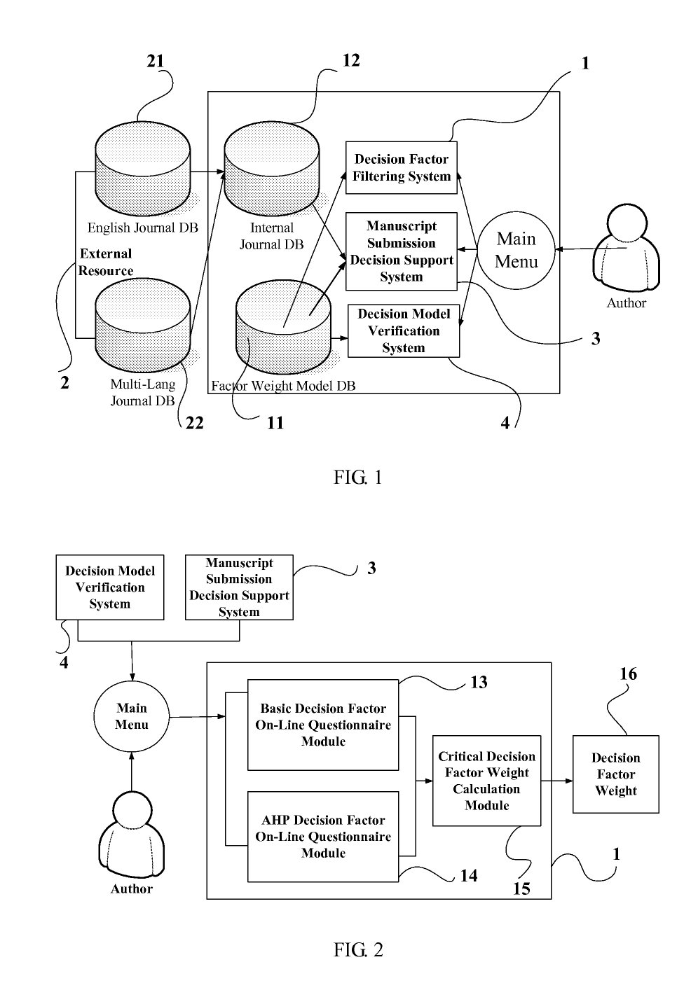

First, please refer to the FIG. 1 which shows the whole sketch map of the Journal Manuscript Submission Decision Support System. This support system is carried out by a physical computer which comprises at least one processor and at least one non-transitory computer-readable storage medium. Preferably, the system comprises a physical interface or browser, such as a screen, electrically connecting to said computer to show a recommended journal list to a user. Wherein, said computer, said processor, said non-transitory computer-readable storage medium and said physical browser are not shown in the drawings. The processor is used to carry out processes relating to calculation. The non-transitory computer-readable storage medium is used to store information therein or to be read information therefrom. The support system comprises the following systems and modules:

### Decision Factor Filtering System (1):

FIG. 2 shows that the framework of Decision Factor Filtering System (1) and a user or an author can enter the process of Decision Factor Filtering System (1) through a Main Manu provided by a physical browser. Basic Decision Factor On-line Questionnaire Module (13) and AHP Decision Factor On-line Questionnaire Module (14) are two major parts in Decision Factor Filter System (1). Through Critical Decision Factor Weight Calculation Module (15) tied to a processor to proceed with statistics analysis, the decision factor weight can be stored at the Factor Weight Model Data Base (11) by a non-transitory computer-readable storage medium. Decision Factor Filtering System (1) is at the early stage. In this stage, author profile and preferences would be collected. Related variables such as article language, indexed database, journal impact factor, article amount of specific subject in journal and journal classification would be ranked by authors via questionnaire. After calculating and ranking procedures, the default weight for each factor would be set and saved at the Factor Weight database tied to a non-transitory computer-readable storage medium. The Manuscript Submission Support System would take advantage of factor weight which output from Decision Factor Filtering System (1).

### External Resource (2):

Referring to FIG. 1, External Source (2), comprising External English Journal DB/database (21) and Multi-Lang Journal DB/database (22), provides the sources to the Internal Journal Database (12). Lots of academic journals are collected in the Internal Journal Database (12) in order to provide rich information and intelligence for the author. Wherein, External Source (2) and Internal Journal Database (12) are connected to a non-transitory computer-readable storage medium to saved the aforementioned information. The more information author get, the more successful decision author make. Therefore, the Internal Journal Database (12) must store all different kinds of peer-reviewed journals.

### Manuscript Submission Decision Support System (3):

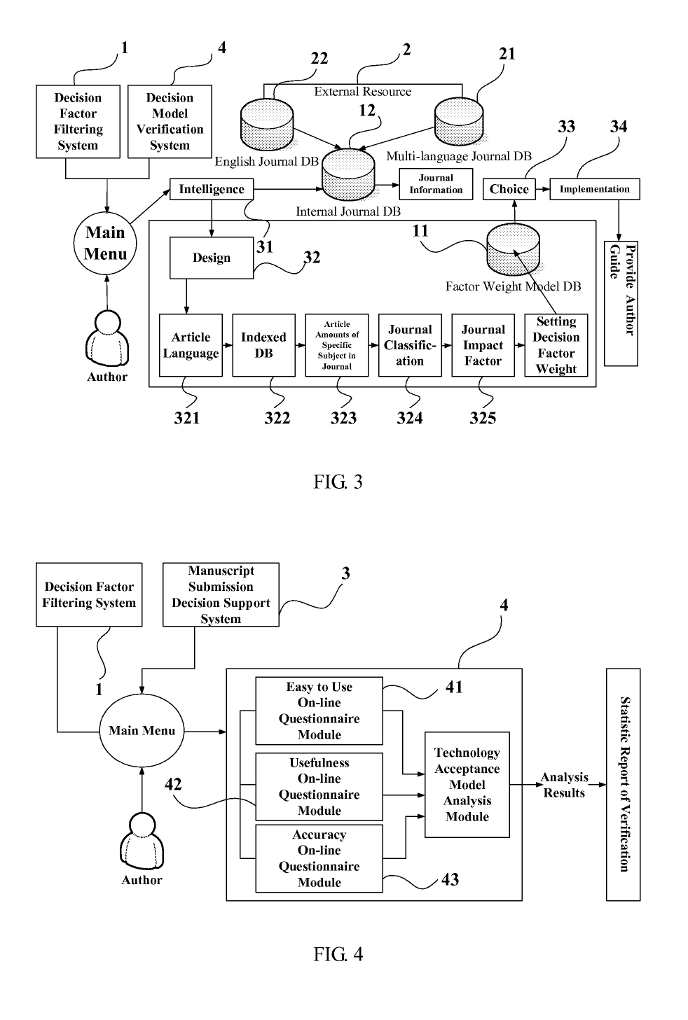

FIG. 3 shows that the framework of Manuscript Submission Decision Support System (3) and a user or an author can enter the process of Manuscript Submission Decision Support System (3) through a Main Manu provided by a physical browser. Manuscript Submission Decision Support System (3), connecting Decision Factor Filtering System (1) with Internal Journal Database (12), helps author proceed with decision analysis and rank journal priority. Manuscript Submission Decision Support System (3) is the major subsystem in the whole system. Simon proposed four decision steps as the following: 1) Intelligence; 2) Design; 3) Choice; 4) Implementation. In the first stage, decision maker would try to collect the more intelligence the more they can. In the second stage, decision maker would develop alternative solutions and use different analysis models. In the third stage, decision maker would rank and evaluate the alternative solutions in order to choose the best one. In the last stage, decision makers would put their choice into practice. This is a classical decision workflow so that the manuscript submission decision support system was designed to follow this. In this Manuscript Submission Decision Support System (3), it also includes four major parts including the Intelligence (31), Design (32), Choice (33) and Implementation (34) system modules. The Manuscript Submission Decision Support System (3) updates its journal information from External Source (2) and connects with Decision Factor Filtering System (1) and Decision Model Verification (4) in order to update the latest decision factor parameter and fine tune the system.

In the Intelligence module (31), it prepares and filters data for Internal Journal DB (12) by parsing External Source (2). The Intelligence module (31) also provides the GUI (Graphic User Interface) through a physical browser to interact with end-users. End Users can survey, browse and search journal information through this module system.

In the Design module (32), the Article Language (321), Indexed DB/database (322), Article Amounts of Specific Subject in Journal (323), Journal Classification (324) and Journal Impact Factor (325) are the major indicators which combine together in order to calculate the suitable submission target. These indicators were filtered and ranked from Decision Factor Filtering System (1). The default weights were calculated through a processor and saved at the Factor Weight Model DB (11) within a non-transitory computer-readable storage medium.

In order to get the article amount of specific subject in journal (323) and Journal Classification (324), the text mining algorithm such as TF-IDF was used. Through TF-IDF analysis, we would learn the hot topic for different journal. The TD-IDF was defined and explained as the follow.

The term count in the given document is simply the number of times a given term appears in that document. This count is usually normalized to prevent a bias towards longer documents to give a measure of the importance of the term tᵢ within the particular document dⱼ. The term frequency was defined as follows:

$${tf}_{i , j} = \frac{{n}_{i , j}}{{Σ}_{k} {n}_{k , j}} \qquad ( 1 )$$

where nᵢⱼ is the number of occurrences of the considered term in document dⱼ, and the denominator is the sum of number of occurrences of all terms in document dⱼ.

The inverse document frequency is a measure of the general importance of the term (obtained by dividing the number of all documents by the number of documents containing the term, and then taking the logarithm of that quotient).

$${idf}_{i} = log \frac{\vert D \vert}{\vert \{ d \text{:} {t}_{i} ∈ d \} \vert} \qquad ( 2 )$$

With

|D|: total number of documents in the corpus

|D:tᵢ ∈ d|: number of documents where the term tᵢ appears (that is n_{i,j}≠0). If the term is not in the corpus, this will lead to a division-by-zero. It is therefore common to use 1+|d:tᵢ ∈d|

Then

(tf−idf)_{i,j}=tf_{i,j}×idfᵢ (3)

The high weight in tf−idf is reached by a high term frequency and a low document frequency of the term in the whole collection of documents; the weights hence tend to filter out common terms.

Journal Impact Factor (JIF) is derived from Journal Citation Report (JCR), a product of Thomson ISI (Institute for Scientific Information). JCR provides quantitative tools for evaluating journals. The impact factor is one of these; it is a measure of the frequency with which the “average article” in a journal has been cited in a given period of time. The impact factor for a journal is calculated based on a three-year period, and can be considered to be the average number of times published papers are cited up to two years after publication. For example, the impact factor 2009 for a journal would be calculated as follows:

Journal Impact factor 2010=X/Y (4)

X=the number of times articles published in 2008-2009 were cited in indexed journals during 2010; and

Y=the number of articles, reviews, proceedings or notes published in 2008-2009.

The ROMC analysis method was used in this research too. This method was proposed by Sprange and Carlson, was used to assist with decision-making from four aspects: 1) Representation, 2) Operation, 3) Memory Aid and 4) Control Mechanisms. To the end-users, Decision Support System should provide the following functions. First, pictures are helpful to make the decision concept clearly. It also helps human beings to communicate with computers. Second, Decision Support System can compute input parameters obtained from user interfaces. Third, Memory Aid, such as a non-transitory computer-readable storage medium, is needed in order to store data generated from presentation and operation steps. Fourth, end-users can control and operate the system. In this research, we map Journal Manuscript Submission Decision Support System to ROMC and Simon's Decision Model. See Table 1 for more details. The ROMC matrix was built and based on Simon's decision model. The detailed ROMC matrix mapped by Journal Manuscript Submission Decision Support System was described as below.

1) Step I: Intelligence—Browse
For the intelligence mode in the Journal Manuscript Submission Decision Support System, ROMC is described as follows: Presentation (R): The user interface on a physical browser is provided to accept query and then display query results. Operation (O): Integrate different databases and filter out results to match query through a processor. Memory Aids (M): Store journal metadata elements and Journal Impact Factor (JIF) through a non-transitory computer-readable storage medium. Control Mechanism (C): Browse journal and set JIF range through a physical browser.

2) Step II: Design—Compare Journals and Provide Feasible Solutions.
(R): List the matched journals after self-evaluation factor and risk factor were calculated on a physical browser. This is the initial feasible solution calculated by a processor and stored in or read from a non-transitory computer-readable storage medium. (O): The list is adjusted and filtered to generated calculation results through a processor. (M): Save calculation results in a non-transitory computer-readable storage medium. (C): End-users gain control over inputting self-evaluation and risk factors through a physical browser.

3) Step III: Choice—Decide on the Target Journals.
(R): The major difference between Step III and Step II is the scoring. In this step, the journal ranking list would be produced by calculating any one of subject code, JIF or paper quantities which is selected by a user from a physical browser. This will be helpful in determining suitable targets or solutions. (O): Based on Formula 6, three parameters, which are code distance, JIF and paper quantities are calculated by Journal Manuscript Submission Support System through a processor. (M): Store weights for further ranking process in a non-transitory computer-readable storage medium. (C): Provide subject's codebook for end-users to choose and let them input article impact factor through a physical browser. In Step III, two types of scoring models were proposed in this study. The Type I model computes the sum of the weights of decision items, as shown in Formula 5. In Sᵣ₁, L is the type of language; N_{K} is the amount on the related topic which has been published; V is the average response time. As the value of Sᵣ₁ increases the journal becomes more suitable for submission. W is the variable's weight, and it is a preset/default value provided from Decision Factor Filtering System (1). End Users can adjust default weight according to their preferences. The Type II model also uses the weight calculation method, as shown in Formula 6. In Sᵣ₂, F is the calculated Journal Impact Factor and N is the subject code; I in F is the self-evaluated impact factor which is the so-called paper impact factor. This factor is equal to the journal impact factor. J in F is the journal impact factor; E in N is the journal's name; C is the thesis title; and E and C are encoded by a codebook. The larger the value of Sᵣ₂ the more suitable the journal is for authors to submit a particular paper.

$$\begin{matrix}{S}_{r 1} = {W}_{l} L + {W}_{k} {N}_{k} + {W}_{p} V & ( 5 ) \\ {S}_{r 2} = {W}_{p} F + {W}_{q} N \\ F = \{ \begin{matrix}\frac{1}{\vert I - J \vert} & if & I \neq J \\ 1.5 & otherwise & I = J\end{matrix} \\ N = \{ \begin{matrix}\frac{1}{\vert E - C \vert} & if & E \neq C \\ 1.5 & otherwise & E = C\end{matrix} & ( 6 )\end{matrix}$$

TABLE 1
Map Journal Manuscript Submission Decision Support System to Matrix of ROMC.

| | Representation | Operation | Memory Aids | Control |
|---|---|---|---|---|
| Intelligence | 1. Journal query screen. | 1. Query and filter | 1. Journal metadata | 1. Browse Journal |
| | 2. Display query results. | journal. | elements database. | information. |
| | | 2. Integrate External | 2. Journal impact | 2. Filter Journal |
| | | Resource. | factor database. | Impact Factor. |
| Design | 1. Feasible solution and | 1. Journal list | 1. Store risk factors. | 1. Input self- |
| | Journal Lists. | operation. | 2. Feasible solution. | evaluation factor. |
| | 2. List Journals which | 2. Fine tune JIF. | | 2. Input fine-tune |
| | are fit to self-evaluation | 3. Journal filtering. | | factor. |
| | results. | | | 3. Input risk factor. |
| Choice | 1. The journal ranking | 1. Calculation for JIF, | 1. Store scores. | 1. Select subject |
| | lists after scoring. | Quantity and Code. | 2. Journal ranking | code. |
| | | 2. Rank journals and | list. | 2. Input journal |
| | | list scores. | | impact factor. |

### Decision Model Verification System (4):

FIG. 4 shows that the framework of Decision Model Verification System (4) and a user or an author can enter the process of Decision Model Verification System (4) through a Main Manu provided by a physical browser. Decision Model Verification System (4) is used to verify and update the decision factor weight stored in the Factor Weight Model DB (11) continuously.

TAM (Technology Acceptance Model) is one of the famous theories in the Management Information System filed. It was proposed by DAVIS in 1989. Both easy-to-use and usefulness are the most important factors to measure and determine software acceptance. The present invention modifies the measurement models and encapsulates them by a support system. In the Decision Model Verification System, three sub-modules are included in the Technology Acceptance Model Analysis module. They are 1) Easy-to-Use online questionnaire module (41); 2) Usefulness on-line questionnaire module (42); and 3) Accuracy online questionnaire module (43). Statistic report is generated in order to verify the decision factor and decision model in the Manuscript Submission Decision Support System (3) and Decision Factor Filtering System (1). This is the while loop procedure. If the result is poor, the decision factor or model would be changed in order to find the better factors or calculation models. We hope to make the Manuscript Submission Decision Support System can reduce author's cost and time to find the suitable journal effectively and decrease the reject rate and turnaround time between authors and journal. Wherein, the implementation module can provide implementation information corresponding to a choice from the journal ranking list by the user. The implementation information, stored in a non-transitory computer-readable storage medium, includes a journal website address, a journal introduction and an author guide. Preferably, the implementation information includes an author guide, a reviewer guide, an editorial board and a journal audience scope.

In this research and development, the new manuscript submission decision support method and system are proposed and implemented. There are no similar patents which unveil the similar techniques. It is accordance to the patent regulation.

While we have shown and described the embodiment in accordance with the present invention, it should be clear to those skilled in the art that further embodiments may be made without departing from the scope of the present invention.

1-11. (canceled)

12. A system tied to at least one computer with a non-transitory computer-readable storage medium for suggesting a user to submit a manuscript to suitable journals, comprising:
a manuscript submission support system having an online question module and a critical decision factor weight calculation module, the online question module providing an online questionnaire to an author so as to collect factor weights in the non-transitory computer-readable storage medium, the factor weights relating to article language, indexed database, journal impact factor and article amount of specific subject in journal and journal classification, the critical decision factor weight calculation module generating default weights from the factor weights by statistic analysis,
a factor weight database for saving the default weights in the non-transitory computer-readable storage medium,
a decision model verification system verifying and updating the default weights stored in the factor weight database based on the Technology Acceptance Model, and
[a]the manuscript submission support system further having a design module and a choice module, the design module connected with the factor weight database to import the default weights from the factor weight database through the non-transitory computer-readable storage medium, the design module providing the default weights for the user to adjust, the choice module producing a journal ranking list based on the default weights adjusted by the user in the design module,
wherein the journal ranking list has a first journal ranking list and a second journal ranking list,
wherein, the first journal ranking list is generated by a first formula Sᵣ₁ which is represented as the following first equation:
Sᵣ₁=WₗL+WₖNₖ+WₚV
wherein, L is a type of languages, Nₖ is the amount on a related topic which has been published, V is an average response time, and Wₗ, Wₖ and Wₚ are the default weights in correspondence with L, Nₖ and V, respectively;
wherein, the second journal ranking list is generated by a second formula Sᵣ₂ which is represented as the following second equation:
Sᵣ₂=WₚF+W_{q}N
wherein, F is a calculated journal impact factor and represented as the following first conditional function:
$$F = \{ \begin{matrix}\frac{1}{\vert I - J \vert} & if & I \neq J \\ 1.5 & otherwise & I = J\end{matrix}$$
wherein, I is a self-evaluated impact factor which is adjusted by the user, J is a journal impact factor;
wherein, N is a subject code and represented as the following second conditional function:
$$N = \{ \begin{matrix}\frac{1}{\vert E - C \vert} & if & E \neq C \\ 1.5 & otherwise & E = C\end{matrix}$$
Wherein, E is a journal name, C is a thesis title, E and C are encoded by a codebook.

13. A system of claim 12, wherein the online questionnaire is designed by the analytic hierarchy process.

14. A system of claim 12, further comprising an internal journal database for collecting and saving journal information via the non-transitory computer-readable storage medium.

15. A system of claim 14, wherein the internal journal database connected to an external journal database, the external journal database having external English journal database and multi-language journal database so that the internal journal database updates journal information from the external journal database.

16. A system of claim 14, further comprising an intelligence module connected with the internal Journal database for providing the user to survey, browse and search the journal information.

17. A system of claim 14, further comprising an implementation module for providing implementation information corresponding to a choice from the journal ranking list by the user.

18. A system of claim 17, wherein the implementation information includes a journal website address, a journal introduction and an author guide.

19. A system of claim 17, wherein the implementation information includes an author guide, a reviewer guide, an editorial board and a journal audience scope.

20. A method implemented by a computer for suggesting a user to submit a manuscript to suitable journals, comprising:
providing an online questionnaire to an author so as to collect factor weights, the factor weights relating to article language, indexed database, journal impact factor and article amount of specific subject in journal and journal classification,
generating default weights from the factor weights by statistic analysis,
saving the default weights to a factor weight database having a non-transitory computer-readable storage medium,
verifying and updating the default weights stored in the factor weight database based on the technology acceptance model, and
importing the default weights from the factor weight database and providing the default weights for the user to adjust,
while the default weights are not adjusted by the user, producing a first journal ranking list,
while the default weights are adjusted by the user, producing a second journal ranking list,
wherein, the first journal ranking list is generated by a first formula Sᵣ₁ which is represented as the following first equation:
Sᵣ₁=WₗL+WₖNₖ+WₚV
wherein, L is a type of languages, Nₖ is the amount on a related topic which has been published, V is an average response time, and Wₗ, Wₖ and Wₚ are the default weights in correspondence with L, Nₖ and V, respectively;
wherein, the second journal ranking list is generated by a second formula Sᵣ₂ which is represented as the following second equation:
Sᵣ₂=WₚF+W_{q}N
Wherein, F is a calculated journal impact factor and represented as the following first conditional function:
$$F = \{ \begin{matrix}\frac{1}{\vert I - J \vert} & if & I \neq J \\ 1.5 & otherwise & I = J\end{matrix}$$
wherein, I is a self-evaluated impact factor which is adjusted by the user, J is a journal impact factor;
wherein, N is a subject code and represented as the following second conditional function:
$$N = \{ \begin{matrix}\frac{1}{\vert E - C \vert} & if & E \neq C \\ 1.5 & otherwise & E = C\end{matrix}$$
Wherein, E is a journal name, C is a thesis title, E and C are encoded by a codebook.
